(19) United States
(12) Patent Application Publication
(10) Pub. No.: US 2016/0196268 A1
(43) Pub. Date: Jul. 7, 2016

(54) PRIORITIZING VIDEO SURVEILLANCE MEDIA

(71) Applicant: International Business Machines Corporation, Armonk, NY (US)

(72) Inventors: Sergio Borger, Sao Paulo (BR); Carlos H. Cardonha, Sao Paulo (BR); Fernando L. Koch, Florianopolis (BR); Ademir F. Silva, Sao Paulo (BR)

(21) Appl. No.: 14/591,128

(22) Filed: Jan. 7, 2015

(51) Int. Cl. G06F 17/30

(52) U.S. Cl. CPC G06F 17/3053; G06F 17/30528; G06F 17/30038

(57) ABSTRACT

People sensing reports are applied to support video surveillance allowing for assigning priority rating in the processing of video and image produced by a video surveillance system based on crowdsensing reports. The present invention addresses a challenge faced by organizations, such as public agencies and/or private companies that employ surveillance systems in order to capture surveillance media.

### FIELD OF THE INVENTION

The present invention relates generally to the field of surveillance and security, and more particularly to the processing of contents recorded by a surveillance system.

### BACKGROUND OF THE INVENTION

People sensing, an emerging paradigm in social computing research, may be defined as a network of interconnected, participatory people who provide observations and/or reports about events occurring within a city and/or other communities, whether intentionally or unintentionally. One example of people sensing is known as “citizen sensing/crowdsensing.” Generally, the objectives include: (i) instrumenting people and/or cities; (ii) interconnecting parties; (iii) analyzing related events; (iv) providing recommendation reports; and/or (v) providing feedback reports.

Personal sensor events are reports by people of situations, including, but not limited to: (i) security threads; (ii) the occurrence of potholes; (iii) pollution in creeks; (iv) traffic jams; and/or (v) problem in public illumination. These sensor events are collected through personal sensor monitors and are used by end-users to report situations as they occur. Personal sensing applications typically run on mobile devices, such as smartphones. The devices running people sensing applications typically provide automated sensors that collect situational information, such as: (i) location; and/or (ii) device orientation. Personal sensing reports may include the combination of end-user annotations and personal sensing information. These reports are transmitted to a remote server where the report data is stored, indexed, and/or grouped. This information is used for running analysis and generating reports.

### SUMMARY

In one aspect of the present invention, a method, a computer program product, and a system for assigning a priority rating to media contents produced by a surveillance system includes: capturing a first set of media contents by the surveillance system at a plurality of locations, storing the first set of media contents in a media contents store(s), media contents in the first set of media contents being assigned a first priority level, collecting a set of event reports, the set of event reports being related to one or more events taking place at a subset of locations of the plurality of locations, identifying a subset of surveillance devices of the surveillance system based on the set of event reports and corresponding location(s) of the one or more events, identifying a second set of media contents stored in the media contents store(s), the second set of media contents being captured by the subset of surveillance devices, changing the first priority level to a second priority level for media contents in the second set of media contents, and analyzing the first set of media contents stored in the media contents store(s) based on a priority level assigned to media contents in the first set of media contents. The second priority level represents a higher priority level than the first priority level. The second set of media contents is a subset of media contents in the first set of media contents.

### BRIEF DESCRIPTION OF THE DRAWINGS

FIG. 1 is a schematic view of a first embodiment of a system according to the present invention;

FIG. 2 is a flowchart showing a method performed, at least in part, by the first embodiment system;

FIG. 3 is a schematic view of a machine logic (for example, software) portion of the first embodiment system for performing the method shown in FIG. 2; and

FIG. 4 is a schematic view of a second embodiment system according to the present invention.

### DETAILED DESCRIPTION

People sensing reports are applied to support video surveillance allowing for assigning priority rating in the processing of video and image produced by a video surveillance system based on crowdsensing reports. The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium, or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network, and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture, including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus, or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions, or acts, or carry out combinations of special purpose hardware and computer instructions.

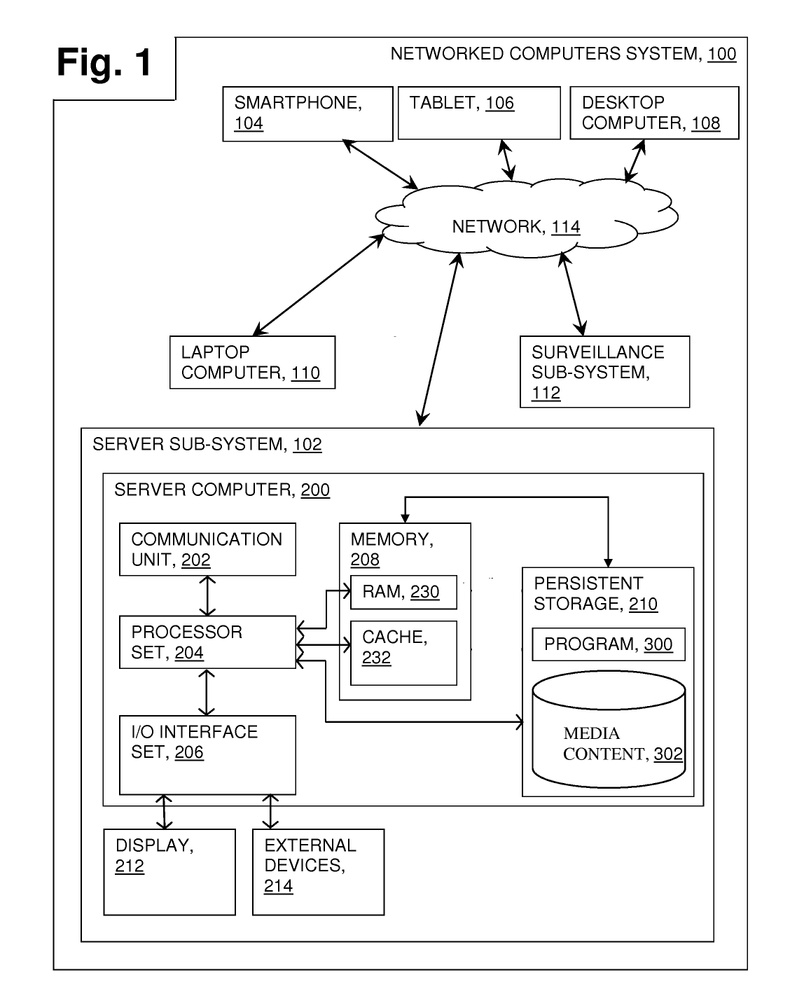

The present invention will now be described in detail with reference to the Figures. FIG. 1 is a functional block diagram illustrating various portions of networked computers system 100, in accordance with one embodiment of the present invention, including: server sub-system 102; smartphone 104; tablet 106; desktop computer 108; laptop computer 110; surveillance sub-system 112; communication network 114; server computer 200; communication unit 202; processor set 204; input/output (I/O) interface set 206; memory device 208; persistent storage device 210; display device 212; external device set 214; random access memory (RAM) devices 230; cache memory device 232; media content 302; and program 300.

Sub-system 102 is, in many respects, representative of the various computer sub-system(s) in the present invention. Accordingly, several portions of sub-system 102 will now be discussed in the following paragraphs.

Sub-system 102 may be a laptop computer, tablet computer, netbook computer, personal computer (PC), a desktop computer, a personal digital assistant (PDA), a smartphone, or any programmable electronic device capable of communicating with the client sub-systems via network 114. Program 300 is a collection of machine readable instructions and/or data that is used to create, manage and control certain software functions that will be discussed in detail below.

Sub-system 102 is capable of communicating with other computer sub-systems via network 114. Network 114 can be, for example, a local area network (LAN), a wide area network (WAN) such as the Internet, or a combination of the two, and can include wired, wireless, or fiber optic connections. In general, network 114 can be any combination of connections and protocols that will support communications between server and client sub-systems.

Sub-system 102 is shown as a block diagram with many double arrows. These double arrows (no separate reference numerals) represent a communications fabric, which provides communications between various components of sub-system 102. This communications fabric can be implemented with any architecture designed for passing data and/or control information between processors (such as microprocessors, communications and network processors, etc.), system memory, peripheral devices, and any other hardware component within a system. For example, the communications fabric can be implemented, at least in part, with one or more buses.

Memory 208 and persistent storage 210 are computer readable storage media. In general, memory 208 can include any suitable volatile or non-volatile computer readable storage media. It is further noted that, now and/or in the near future: (i) external device(s) 214 may be able to supply, some or all, memory for sub-system 102; and/or (ii) devices external to sub-system 102 may be able to provide memory for sub-system 102.

Program 300 is stored in persistent storage 210 for access and/or execution by one or more of the respective computer processors 204, usually through one or more memories of memory 208. Persistent storage 210: (i) is at least more persistent than a signal in transit; (ii) stores the program (including its soft logic and/or data), on a tangible medium (such as magnetic or optical domains); and (iii) is substantially less persistent than permanent storage. Alternatively, data storage may be more persistent and/or permanent than the type of storage provided by persistent storage 210.

Program 300 may include both machine readable and performable instructions, and/or substantive data (that is, the type of data stored in a database). In this particular embodiment, persistent storage 210 includes a magnetic hard disk drive. To name some possible variations, persistent storage 210 may include a solid state hard drive, a semiconductor storage device, read-only memory (ROM), erasable programmable read-only memory (EPROM), flash memory, or any other computer readable storage media that is capable of storing program instructions or digital information.

The media used by persistent storage 210 may also be removable. For example, a removable hard drive may be used for persistent storage 210. Other examples include optical and magnetic disks, thumb drives, and smart cards that are inserted into a drive for transfer onto another computer readable storage medium that is also part of persistent storage 210.

Communications unit 202, in these examples, provides for communications with other data processing systems or devices external to sub-system 102. In these examples, communications unit 202 includes one or more network interface cards. Communications unit 202 may provide communications through the use of either, or both, physical and wireless communications links. Any software modules discussed herein may be downloaded to a persistent storage device (such as persistent storage device 210) through a communications unit (such as communications unit 202).

I/O interface set 206 allows for input and output of data with other devices that may be connected locally in data communication with server computer 200. For example, I/O interface set 206 provides a connection to external device set 214. External device set 214 will typically include devices such as a keyboard, keypad, a touch screen, and/or some other suitable input device. External device set 214 can also include portable computer readable storage media such as, for example, thumb drives, portable optical or magnetic disks, and memory cards. Software and data used to practice embodiments of the present invention, for example, program 300, can be stored on such portable computer readable storage media. In these embodiments the relevant software may (or may not) be loaded, in whole or in part, onto persistent storage device 210 via I/O interface set 206. I/O interface set 206 also connects in data communication with display device 212.

Display device 212 provides a mechanism to display data to a user and may be, for example, a computer monitor or a smartphone display screen.

The programs described herein are identified based upon the application for which they are implemented in a specific embodiment of the present invention. However, it should be appreciated that any particular program nomenclature herein is used merely for convenience, and thus the present invention should not be limited to use solely in any specific application identified and/or implied by such nomenclature.

Program 300, along with media content 302, operates to collect, store, index, and/or analyze media contents that are captured and submitted by surveillance sub-system 112 via, for example, network 114. The media contents include video, audio, and/or images. Further, program 300 operates to collect and/or analyze the reports submitted by users and/or subscribers using devices such as smartphone 104, tablet 106, and laptop computer 110.

Some embodiments of the present invention provide a system and a method for assigning priority rating in the processing of media (e.g., video footage and still images) produced by a video surveillance system based on personal sensing reports.

In some embodiments of the present invention, a video surveillance system refers to an infrastructure composed of: (i) video camera(s); (ii) a communication structure; (iii) and shared IT infrastructure subsystem(s) (e.g. cloud computing networks, servers, and other subsystems) built to capture, store, index, and/or analyze live video streams, or still images, referred to herein as “surveillance media”. Surveillance media may be captured from multiple points of view and from different locations. Surveillance systems may provide solutions related to security and monitoring in different domains. Automated methods for surveillance media analysis require software modules to process captured video streams, or still images. In some embodiments, these methods are specialized in analyzing one or few aspects of the captured media, for example, modules may include: (i) face capturing; (ii) face recognition; (iii) object tracking; and/or (iv) object recognition. Due to the large data volume and complexity of live media analysis, these software modules are usually resource-demanding. As such, methods for optimizing the allocation of resources, activation of methods, and other strategies to make processing feasible in a shared IT infrastructure are useful.

Some embodiments of the present invention provide a solution to prioritize media material (e.g., images and video) captured by surveillance systems based on reports submitted through a personal sensing platform (PSP) (via, for example, applications running on mobile devices). Some embodiments of the present invention identify parts of the captured content that are more likely to contain evidences of relevant events and, consequently, the particular media that should be analyzed earlier and/or with closer attention.

Some embodiments of the present invention address a challenge faced by organizations, such as public agencies and/or private companies, that employ surveillance systems in order to capture surveillance media (e.g. video, sound, images). Oftentimes surveillance media is used to record and/or identify extraordinary events, such as illegal activity, threats of nature, and/or other events that may have an adverse effect in a region. The volume of data produced by surveillance systems may be very large and the verification process is typically performed manually. Accordingly, assigning priority to the captured surveillance media supports: (i) recommending actions for analysis work, as one typically wants to identify which verification tasks are more important and/or more urgent; and/or (ii) accelerating the identification of extraordinary events.

An example follows where an urban event scenario is considered in which video cameras are located in strategic street corners providing street views. In this scenario, a number of people are equipped with smartphone devices running a personal monitor solution. People use this application to report urban events, such as potholes in the sidewalks, flooded streets, and/or illegal activity in the surrounding area, etc. These personal sensing reports are transmitted to a central server, or otherwise isolated, where the reports are processed and analyzed. Based on these personal sensing reports, the central server is able to recommend a set of surveillance cameras for increased scrutiny. For example, if there are numerous personal sensing reports indicating illegal activity in a specific area, the central server calls for close review of the surveillance media being captured by surveillance covering that specific area.

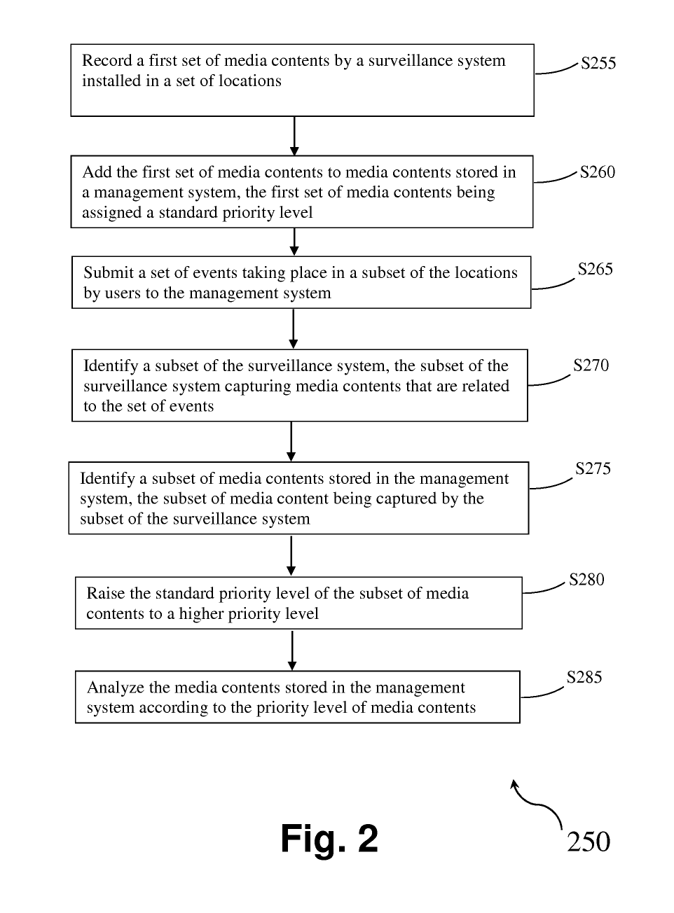

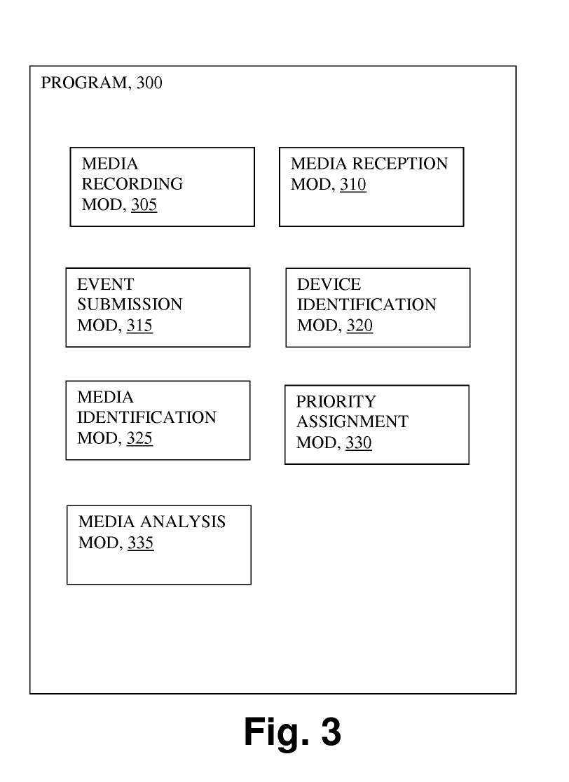

FIG. 2 shows flowchart 250 depicting a first method according to the present invention. FIG. 3 shows program 300 for performing at least some of the method steps of flowchart 250. This method and associated software will now be discussed, over the course of the following paragraphs, with extensive reference to FIG. 2 (for the method step blocks) and FIG. 3 (for the software blocks).

Processing begins at step S255, where media recording module (“mod”) 305 records a first set of media contents by a surveillance system installed in a first set of locations. The media contents include, but are not limited to: (i) video; (ii) audio; and/or (iii) still images. In this example, surveillance equipment is installed in a plurality of positions in a city, including: (i) a street corner where traffic jams frequently occur; (ii) in front of a selected building where security is of particular concern; and (iii) in an area that is poorly lit . Alternatively, the surveillance equipment is installed in every hallway inside a selected building. Alternatively, the surveillance equipment is installed in a shopping mall to monitor shoppers. Alternatively, the surveillance equipment is installed in a factory to monitor the production floor. Alternatively, the surveillance equipment is installed in an office building to monitor office activity. Alternatively, the surveillance equipment is installed in a school building to monitor hallways and/or classrooms.

The surveillance system includes, but is not limited to: (i) one or more surveillance detectors (e.g., cameras and audio recorders); (ii) a computer having an input for the surveillance detectors and one or more event report inputs (e.g., from participants); and/or (iii) a controller that increases a level of surveillance based on the event report inputs (or reported information in the reports). The controller may increases the level of detail in the surveillance system by, for example: (i) activating more surveillance detectors; (ii) adjusting directional placement of surveillance detector(s); (iii) adjusting the capture-rate of surveillance detector(s); (iv) increasing resolution of input; (v) increasing the quality of input; and/or (vi) making other adjustments to input detector(s).

In some embodiments, the level of surveillance includes one or more of the following: (i) the number of surveillance detectors that are turned on; (ii) the directional placement of the surveillance detector(s); (iii) a detector focal length; and/or (iv) a detector frame rate.

Processing proceeds to step S260, where media reception module 310 adds the first set of media contents to media contents stored in a management system. The first set of media contents are assigned a standard priority level, for example, a priority level 1 on a scale of 1 to 5 where the 1 refers to a lowest (or standard) priority level. Alternatively, a priority level scale is represented by different colors, e.g., blue representing a lowest (or standard) level and red representing a highest level. In some embodiments, the management system includes media content database 302 and a central server (e.g., server sub-system 102). In this exemplary embodiment, the management system stores media contents prior to the addition of the first set of media contents captured by the surveillance system. In some embodiments, the management system does not contain any media contents prior to the addition of the first set of media contents. In some embodiments, the media contents stored in the management system after the addition of the first set of media contents all have a standard priority level. Alternatively, the media contents stored in the management system after the addition of the first set of media contents have different priority levels.

Processing proceeds to step S265, where event submission module 315 collects a set of events taking place in a subset of the locations reported by users to the management system. In some embodiments, the locations where the events taking place are submitted by users are not a subset of the locations where the surveillance system is installed. Alternatively, the locations where the events occur partially overlap with the locations where the surveillance system is installed. Additionally, the report may consist of geo-tagged reports provided by users of a personal sensing platform (through, for example, applications running on mobile devices). The personal sensing reports may further be time-stamped. Mobile (or portable) devices include: (i) cellular phones (smartphones); and (ii) tablets. These devices are equipped with an application enabling users to send reports related to events taking place in locations where they are present.

In some embodiments, the event reports include one or more of the following: (i) the number of reports; (ii) the location of the reporter (or user); (iii) the reporter's classification of event; (iv) the reporter's annotation of the event (e.g., through text and/or voice capture); (v) the reporter's picture taken of the event; (vi) sentiment analysis of the reporter's text and/or voice capture; (vii) analysis of geographically related events; (viii) ranking of reports by peer reporters; and/or (ix) correlation of event reports with actual events stored in a central events database.

In some embodiments, a filter is applied to pass report information having a level of credibility. The level of credibility is based on one or more models of analysis of the personal sensing reports, including: (i) counting of the number of reports; (ii) clustering of similar reports; (iii) grouping of geographically related reports; and/or (iv) ranking of reports by peer reporters.

In some embodiments, a classifier is used to classify the reported information by report type. Report types include one or more of the following: (i) fire; (ii) illegal activity; (iii) traffic accident; (iv) infrastructure event; (v) urban event; (vi) service event; (vii) weather-related event; (viii) transit event; and (ix) natural event.

In some embodiments, the reported information is routed to a corresponding processing location according to the report type, processing locations including: (i) fire station; (ii) police station; (iii) maintenance services facility; and/or (iv) central operation center.

In some embodiments, a confidence generator is employed to provide a degree of credibility (or confidence) in the reported information.

Processing proceeds to step S270, where device identification module 320 identifies a subset of the surveillance system that captures media contents related to the set of events reported by users in step S265. In some embodiments, this identification is made based on the time when the reports are made. Alternatively, this identification is made according to the location where the reports are made. The principle being that content of interest is likely to have been captured by surveillance devices in close proximity to the locations at time intervals corresponding to the time stamps.

Processing proceeds to step S275, where media identification mod 325 identifies a subset of media content stored in the management system. The subset of media content is captured by the subset of the surveillance system at the locations and the time periods corresponding to the reports of events submitted by a user.

Processing proceeds to step S280, where priority assignment module 330 updates the priority level of the subset of media content identified in step S275, including the surveillance media produced by the subset of surveillance system identified in step S270 related to the same events reported by the user in step S265. Updating the priority level, as referred to herein, includes assigning the subset of media content a higher priority level than the standard priority level that is initially assigned to all surveillance media. For example, the priority level of the subset of media content is increased from the standard priority level 1 on a scale of 1 to 5 to a higher priority level 3, or level 4, or even the highest level 5, based on the relevance of the subset of media content with respect to the events reported by one or more users. Alternatively, the priority level of the subset of media content is increased from the standard blue level, in a colored scale, to a higher orange level, or even the highest red level, based on the relevance of the subset of media content with respect to the events reported by users.

Processing ends at step S285, where media analysis module 335 analyzes the set of media content, also referred to as surveillance media, stored in the management system according to the priority level of media contents. In some embodiments, only the set of media content captured by the subset of surveillance system are analyzed. Alternatively, all the media content stored in the management system are analyzed in accordance with the order defined by their respective priorities. As such, operators of the surveillance system are aware of what media content to pay attention to, thereby providing more efficient and precise results in a shorter amount of time. In some embodiments, an analysis report is generated to support, for example, law enforcement or disaster recovery organizations, in delivering a quick solution. By providing for quick processing of surveillance media in a shared IT infrastructure, the quality of services and the allocation of resources is improved.

In some embodiments, the surveillance system or a subset of devices of the surveillance system are initially “inactive”, i.e., initially surveillance media (video, audio, images) is not captured. Users send a set of event reports related to events taking place in a location (e.g., city, office building, and shopping center) to a central and/or remote server through a personal reporting application running on portable devices. Upon receipt of the set of event reports by the central server, the central server identifies a set of surveillance devices, e.g., cameras that are located near the observation points of the users. The central server further delivers activation signals to the identified set of surveillance devices to turn on those devices and start capturing surveillance media.

In some embodiments, the central server further generates a report recommending the number of operators and/or processing resources required to process the predicted amount of surveillance media to be produced by the identified surveillance devices. The identified surveillance devices capture a set of media contents during a specified period of time (e.g., 5 minutes), and submit the captured set of media contents to the central server for further analysis. In some embodiments, the surveillance system and/or surveillance devices are always active, having modifiable capturing configurations (e.g. frames per second, and capture quality.)

Some embodiments of the present invention may include one, or more, of the following features, characteristics, and/or advantages: (i) personal sensing reports to prioritize media content captured by surveillance systems; (ii) platforms that have potential to be large providers of information; (iii) efficient implementations of surveillance media processing; (iv) delivers more precise results in shorter amounts of time than conventional systems; (v) provides a crucial contribution in raising awareness of processing entities as to what images are likely the most important; and/or (vi) increased quality of services by helping processing entities avoid distractions caused by fatigue.

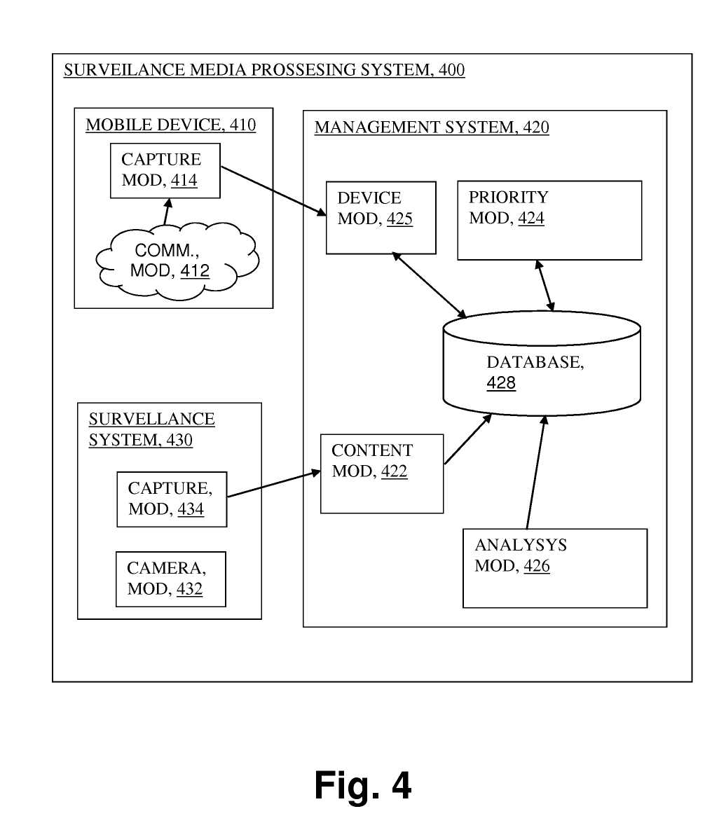

FIG. 4 is a block diagram of surveillance media processing system 400 for practicing a method according to an embodiment of the present invention. System 400 includes: mobile device 410; mobile network communication module 412; mobile capture module 414; management system 420; add content module 422; surveillance device module 425; priority module 424; analysis module 426; media content database 428; surveillance system 430; surveillance camera module 432; and camera capture module 434.

According to a process practiced by system 400, processing begins where surveillance camera module 432 records surveillance media content in certain locations of a city. In this example, the media content is referred to as “set C of media content.” Set C of media content is recorded by the camera module at locations x, y, and z of city A.

Processing proceeds where camera capture module stores set C of media content in media content database 428 of management system 420.

Processing proceeds where add content module 422 establishes a “normal” priority level for set C of media content and adds set C of media content to set M of media content, where set M of media content already exists in database 428.

Processing proceeds where mobile capture module 414 captures user reports via mobile network communication module 412. In this example, the mobile capture mod captures set R of users reports. The set R of users reports includes time-stamped and geo-tagged reports of events taking place at locations x and y of city A.

Processing proceeds where surveillance device module 425 identifies set D of surveillance devices that have captured content related to events related to set R of users reports. In this example, identification of set D is based on the time when reports of set R corresponds to locations X and/or Y where devices in set D are positioned. This recognizes that interesting content may have been captured by surveillance devices close to the locations in time intervals containing the time stamps.

Processing proceeds where priority module 424 updates the priority levels of subset U of set M of media content stored in database 428. Subset U of media content is the media content produced by set D of surveillance devices for the same events reported in set R of users reports.

Processing proceeds where analysis module 426 analyzes the media content in set M of media content according to current priority levels.

Some helpful definitions follow:

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein that are believed as maybe being new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

and/or: inclusive or; for example, A, B “and/or” C means that at least one of A or B or C is true and applicable.

User/subscriber: includes, but is not necessarily limited to, the following: (i) a single individual human; (ii) an artificial intelligence entity with sufficient intelligence to act as a user or subscriber; and/or (iii) a group of related users or subscribers.

Computer: any device with significant data processing and/or machine readable instruction reading capabilities including, but not limited to: desktop computers, mainframe computers, laptop computers, field-programmable gate array (FPGA) based devices, smartphones, personal digital assistants (PDAs), body-mounted or inserted computers, embedded device style computers, application-specific integrated circuit (ASIC) based devices.

What is claimed is:

1. A method for assigning a priority rating to media contents produced by a surveillance system, the method comprising:
capturing a first set of media contents by the surveillance system at a plurality of locations;
storing the first set of media contents in a media contents store(s), media contents in the first set of media contents being assigned a first priority level;
collecting a set of event reports, the set of event reports being related to one or more events taking place at a subset of locations of the plurality of locations;
identifying a subset of surveillance devices of the surveillance system based on the set of event reports and corresponding location(s) of the one or more events;
identifying a second set of media contents stored in the media contents store(s), the second set of media contents being captured by the subset of surveillance devices;
changing the first priority level to a second priority level for media contents in the second set of media contents; and
analyzing the first set of media contents stored in the media contents store(s) based on a priority level assigned to media contents in the first set of media contents;
wherein:
the second priority level represents a higher priority level than the first priority level;
the second set of media contents is a subset of media contents in the first set of media contents; and
at least the collecting, identifying, and analyzing steps are performed by computer software running on computer hardware.

2. The method of claim 1, wherein the first set of media contents includes: video, audio, and/or still images.

3. The method of claim 1, further comprising:
grouping the first set of media contents according to the set of event reports.

4. The method of claim 1, wherein at least one event report of the set of event reports is provided by a user using a crowdsensing report application.

5. The method of claim 4, wherein the crowdsensing report application operates on one of the user's smartphone, laptop computer, tablet computer, and desktop computer.

6. The method of claim 1, further comprising:
activating the surveillance system by an administrator.

7. The method of claim 6, further comprising:
activating the subset of surveillance devices to capture additional media contents;
assigning a third priority level to the additional media contents, based on the set of event reports and corresponding locations of the one or more events;
storing the additional media contents in the media contents store(s) to create a third set of media contents; and
analyzing the third set of media contents based on a priority level assigned to media contents in the third set of media contents; and
wherein:
the third priority level represents a higher priority level than the first priority level; and
the third set of media contents includes the first set of media contents.

8. The method of claim 1, wherein the surveillance system includes the following surveillance devices:
one or more surveillance detectors including a video camera, a still image camera, and/or an audio recorder;
a computer for receiving input from the one or more surveillance detectors, and for receiving one or more event reports; and
a controller for adjusting a level of surveillance.

9. The method of claim 8, wherein adjusting the level of surveillance includes one of activating a surveillance detector, adjusting a directional placement of a surveillance detector, augmenting a capture rate of a surveillance detector, adjusting a focal length of a surveillance detector, and increasing an image resolution level of input from a surveillance detector.

10. The method of claim 1, wherein an event report of the set of event reports includes at least one of a count of event reports, a location of a user providing an event report, a classification of an event, an annotation of a third set of media contents, a sentiment analysis of a fourth set of media contents, an analysis of a set of geographically related events, a ranking of event reports, and a correlation of event reports.

11. The method of claim 1, further comprising:
routing the set of event reports to a corresponding processing location including: (i) a fire station; (ii) a police station; (iii) maintenance services; and/or (iv) a central operation center.

12. The method of claim 1, wherein the plurality of locations are public areas.

13. A computer program product for assigning a priority rating to media contents produced by a surveillance system, the computer program product comprising a computer readable storage medium having stored thereon:
first program instructions programmed to capture a first set of media contents by the surveillance system at a plurality of locations;
second program instructions programmed to store the first set of media contents in a media contents store(s), media contents in the first set of media contents being assigned a first priority level;
third program instructions programmed to collect a set of event reports, the set of event reports being related to one or more events taking place at a subset of locations of the plurality of locations;
fourth program instructions programmed to identify a subset of surveillance devices of the surveillance system based on the set of event reports and corresponding location(s) of the one or more events;
fifth program instructions programmed to identify a second set of media contents stored in the media contents store(s), the second set of media contents being captured by the subset of the surveillance devices;
sixth program instructions programmed to change the first priority level to a second priority level for media contents in the second set of media contents; and
seventh program instructions programmed to analyze the first set of media contents stored in the media contents store(s) based on a priority level assigned to media contents in the first set of media contents;
wherein:
the second priority level represents a higher priority level than the first priority level; and
the second set of media contents is a subset of media contents in the first set of media contents.

14. The computer program product of claim 13, wherein the first set of media contents includes: video, audio, and/or still images.

15. The computer program product of claim 13, further comprising:
eighth program instructions programmed to group the first set of media contents according to the set of event reports.

16. The computer program product of claim 13, wherein the crowdsensing report application operates on one of the user's smartphone, laptop computer, tablet computer, and desktop computer.

17. The computer program product of claim 13, wherein an event report of the set of event reports includes at least one of a count of event reports, a location of a user providing an event report, a classification of an event, an annotation of a third set of media contents, a sentiment analysis of a fourth set of media contents, an analysis of a set of geographically related events, a ranking of event reports, and a correlation of event reports.

18. A computer system for assigning a priority rating to media contents produced by a surveillance system, the computer system comprising:
a processor(s) set; and
a computer readable storage medium;
wherein:
the processor set is structured, located, connected, and/or programmed to run program instructions stored on the computer readable storage medium; and
the program instructions include:
first program instructions programmed to capture a first set of media contents by the surveillance system at a plurality of locations;
second program instructions programmed to store the first set of media contents in a media contents store(s), media contents in the first set of media contents being assigned a first priority level;
third program instructions programmed to collect a set of event reports, the set of event reports being related to one or more events taking place at a subset of locations of the plurality of locations;
fourth program instructions programmed to identify a subset of surveillance devices of the surveillance system based on the set of event reports and corresponding location(s) of the one or more events;
fifth program instructions programmed to identify a second set of media contents stored in the media contents store(s), the second set of media contents being captured by the subset of the surveillance devices;
sixth program instructions programmed to change the first priority level to a second priority level for media contents in the second set of media contents; and
seventh program instructions programmed to analyze the first set of media contents stored in the media contents store(s) based on a priority level assigned to media contents in the first set of media contents;
wherein:
the second priority level represents a higher priority level than the first priority level; and
the second set of media contents is a subset of media contents in the first set of media contents.

19. The computer system of claim 18, the surveillance system includes the following surveillance devices:
one or more surveillance detectors including a video camera, a still image camera, and/or an audio recorder;
a computer for receiving input from the one or more surveillance detectors, and for receiving one or more event reports; and
a controller for adjusting a level of surveillance.

20. The computer system of claim 19, wherein adjusting the level of surveillance includes program instructions programmed to perform one of activating a surveillance detector, adjusting a directional placement of a surveillance detector, augmenting a capture rate of a surveillance detector, adjusting a focal length of a surveillance detector, and increasing an image resolution level of input from a surveillance detector.
